(19) United States
(12) Patent Application Publication
(10) Pub. No.: US 2005/0075234 A1
(43) Pub. Date: Apr. 7, 2005

(54) Optical glass

(76) Inventors: Silke Wolff, Hueckeswagen (DE); Ute Woelfel, Mainz (DE); Karl Mennemann, Taunusstein (DE)

Correspondence Address: Striker Striker & Stenby, 103 East Neck Road, Huntington, NY, 11743, US

(21) Appl. No.: 10/502,167

(22) PCT Filed: Jan. 28, 2003
(86) PCT No.: PCT/DE03/00223

(30) Foreign Application Priority Data
Jan. 28, 2002 (DE) 102 03 226.2

(51) Int. Cl. C03C 3/07; C03C 3/072; C03C 3/074

(52) U.S. Cl. 501/74; 65/116; 501/75; 501/76

(57) ABSTRACT

The invention relates to optical glasses that are composed as follows: 5-35% by weight of SiO₂, 55-88% by weight of PbO; 0-10% by weight of B₂O₃; 0-5% by weight of Na₂O, 0-5% by weight of K₂O; 0-10% by weight of TiO₂, 0-10% by weight of ZrO₂; 0-10% by weight of La₂O₃; 0-10% by weight of BaO; 0-10% by weight of ZnO, with the proviso that S(Na₂O; K₂O): 0=x=8 and S(TiO₂; ZrO₂; La₂O₃; ZnO; BaO): x=15. The glasses are particularly suitable for LCD projection purposes, especially rLCD projectors. The inventive glasses are glasses from the heavy flint-glass and lanthane heavy flint glass type and have a stress-optical coefficient approaching zero while having a good chemical resistance and sufficient Knoop hardness and are characterized by excellent melting and workability properties. They are therefore suitable for use in fields of application that benefit from low stress-optical effects.

The present invention relates to an optical glass, in particular an optical glass for projection purposes using LCD projectors, and its application.

Market development in the sector of projection is moving continually in the direction of larger projection areas. As a result, the requirements for projection devices in terms of light yield and resolution of the projected image are increasing dramatically. Light yield determines the illumination of the irradiated area, and resolution determines the number of possible picture elements (pixels). If the resolution is too low, the image appears grainy.

The core of a projection device is the modulation system that impresses the desired image to be projected onto the projection area onto the light beam coming from a light source.

To this end, the light beam is broken down into its primary colors (red, green, blue) and the desired modulation is impressed onto each component beam using an LCD (liquid crystal display). The component beams are then recombined.

There is a wide variety of modulation systems, each being composed of filters, beam splitters and an LCD array. If an electrical voltage is applied to an LCD cell in an LCD array, the spacial orientation of the liquid crystal molecules changes and, therefore, so does the optical state of the cell. To enable separate control of each of these cells, each one is connected via a control unit with a voltage source so it can take on the state “with voltage” or “without voltage” and/or “on” and “off”.

There are two types of liquid crystals for modulating light beams: In one case, “on” means light-transmitting, and “off” means non-light-transmitting. This group forms the transmissive LDCs (tLCD), which is based on a transmissive light path. In the case of a second group, the incident light is reflected. With this group, “on” means that the polarization plane of the incident and reflected light is rotated by π/2. In the “off” state, the original polarization remains unchanged. This group forms the reflective LCDs (rLCD).

With tLCD systems, the cells switched to “on” allow light to pass, and the cells switched to “off” absorb or scatter it.

In rLCD systems, however, the image is impressed onto the three component beams of a projection apparatus by rotating the polarization plane instead of masking out the component beams. To accomplish this, the incident light beam is first polarized using polarizing filters and then divided into its primary colors using a beam splitter. In rLCDs, the property of “polarization plane rotated” or “polarization plane not rotated” is then impressed onto the beams. In addition, the beams are reflected. The beams that have been modified in this fashion pass through the beam splitter in the reverse direction are then are recombined. Finally, a downstream polarizing filter having the same orientation filters the non-rotated portions of the three primary colors out of the unified beam.

To enable individual control of each cell (also referred to as a “pixel”) of an LCD array, the cell requires a dedicated electronic control unit. With tLCD arrays, this control unit makes use of a portion of the cell area through which light can no longer pass through; as a result, the light yield is reduced. With rLCD arrays, the light beam is reflected, so the control unit can therefore be located on the back side of the cells without any loss of light.

Despite their basically better operating principle, rLCD projectors have not yet been able to fulfill the expectations placed on them. The depth of contrast of the images that has been achieved is not sufficient for a high-quality projection, combined with the fact that color fringes are observed.

It has been determined that the unexpected problems of this technique are due to optical components such as beam splitters, polarizers and prisms that were adapted to the material, and not to the operating principle. In conventional tLCD devices, transmission and absorption are the prevailing projection principles. The entire light path is therefore independent of the mechanical state of stress of the material.

The optical system of the rLCD devices also reacts in a highly sensitive manner to the slightest spacial deformations with very high contrast loss and color fringes.

For purposes of explanation, the projection procedure with an rLCD system will be discussed in greater detail:

The white light beam from a light source is polarized by an upstream polarizing filter and then falls on a polarizing beam splitter (PBS) that reflects the light whose polarization plane matches that of the polarizing filter and that allows light to pass that is rotated by π/2, i.e., 90°, relative to the polarization plane. One hundred percent of the light polarized by the upstream polarizing filter is diverted via reflectance. The beam then falls on the beam splitter itself, which is composed of four connected prisms, for example, the inner interfaces of which are coated with color steep-edged filter layers. Via selective diversion, this beam splitter separates the white light beam in accordance with its wavelength into the component beams for the three primary colors. One skilled in the art is familiar with a large number of configurations for beam splitters, however, that do not necessarily contain prisms.

The color beams that exit the beam splitter fall onto the rLCDs and completely illuminate each one of them. The light now finds the “on” and “off” pixels described above; its polarization plane is rotated or maintained accordingly. In any case, the light is reflected and travels—in accordance with its wavelength—back along the path through the beam splitter to the PBS. On the way back through the beam splitter, the three component beams—which now contain the information about the entire image in the form of polarization state location information—are recombined.

The white light beam that results is now separated in the PBS according to the polarization state of the wave trains. Trains with a non-rotated polarization plane are diverted by 90°, like the incident beam, and therefore exit the projection beam path in the direction of the light source. Trains with a rotated polarization plane are allowed to pass through directly and reach the projection area, where they produce the desired image.

The light therefore travels through glass across a large portion of the path. Under unfavorable conditions, the glass now has the property, however, of rotating the polarization plane of the light that is passing through. Just tilting the polarization plane slightly causes the vector components of the light that contribute to the projection to be weakened, with great sensitivity. A reduced light yield and, therefore, a greatly reduced contrast result.

This “stress-optical” effect of rotating the polarization plane of incident polarized light is induced in glass, for example, when fine annealing in the manufacturing process is inadequate. As a result, structural stresses are frozen in the glass, which result in different material and, therefore, different electron densities in the spacial directions. Since the refractive index of a material is defined by its electron density in the direction of radiation, this results in refractive indices in the various directions in space that deviate from one another. The material is optically anisotropic. If a linearly polarized wave train hits the material, its vectorial components are refracted with different degrees of intensity in the various directions in space, which is equivalent to a rotation of the polarization plane.

Differences in the ambient temperature and strong mechanical stresses typically also result in the polarization plane being rotated, because, in this case, stresses are induced in the glass by external effects (temperature difference/pressure).

The color fringes observed are also induced by the optical anisotropy. When coupled out of the material, the beam components that are refracted differently are sent into various directions in space, which results in interference phenomena. In addition, the difference in the refractive index is wavelength-dependent, which imparts the multicolored character of color fringes to the interference phenomena (birefringence).

It is therefore obvious to optimize the glasses used in rLCD projectors using a particularly careful cooling process during manufacture and to thereby largely eliminate the internal stresses in the glass. Without stresses, the materials are isotropic and exhibit none of the negative effects described hereinabove.

One point that is overlooked, however, is the fact that projection devices are relatively small to enable easy handling. The optical components in these devices are therefore exposed to strong temperature differences and temperature changes of up to nearly 50° C., at start-up in particular. These temperature differences result in severe stresses in the glass.

Given equal tension, the intensity of the resultant optical effects also depends on the type of glass, because, due to the different glass structures, the effects of stresses differ in intensity also from an optical perspective. To quantitatively describe the stress-optical effect and the resultant birefringence and rotation of the polarization vector, one therefore relies on a material-specific variable, the stress-optical coefficient K.

The effects of an induced stress on the refractive index therefore depend on the orientation, in accordance with the density anisotropy produced. Two components therefore result, the photoelastic constants in the directions a) parallel to the acting stress, and b) perpendicular thereto:
K₌=dn_{c}/dσ and K_{⊥}=dn_{⊥}/dσ in [mm²/N].

If the photoelastic constants are the same in both orientations, an optical effect does not occur, and the material acts in an isotropic manner despite stresses. This is the case with only a few glasses, however. In nearly every case there is a difference between the two components and, therefore, a defined optical effect that is capable of being quantified based on this difference. The stress-optical coefficient then results from K=K₌−K_{⊥ in [mm}²/N].

A reasonable optimization of glass for use in projection can therefore only be a glass having a stress-optical coefficient approaching zero and/or an equalization of the photoelastic constants in the two directions.

The glass types known heretofore do not have an acceptable relationship between a small K value and its chemical resistance and Knoop hardness, however, because the very components that lower the K value in the glass matrix (e.g., lead and phosphate) due to their high polarizability also make the matrix particularly easily to influence and attack chemically and physically due to this specific property.

A slight chemical resistance of the glass does not first become relevant during its use. If this were the case, the problem could be eliminated by using a protective varnish, for example. If chemical resistance is too low and, above all, if Knoop hardness is too low, this first becomes noticeable during cold aftertreatment of the optical components. Efflorescence, interference color effects and surface crystallization occur during this cold aftertreatment, i.e., in a phase in which no protective varnish or the like can be used. In the standard machines that are used for cold aftertreatment, a Knoop hardness that is too low results in enormous surface removal rates that are difficult to control.

The object of the invention, therefore, is to create an optical glass with sufficient chemical resistance and Knoop hardness that has such a low stress-optical coefficient that it can be used in the field of projection, in particular for LCDs.

This object is attained according to the invention with the optical glass indicated in claim 1. Advantageous configurations of the invention are indicated in the subclaims.

The present invention is directed to the heavy flint glasses, such as those sold by the Schott company, Mainz, for example, under the trade names SF 56, SF 57, SF 58 and SF 59. These glasses are silicate of lead glasses containing a high quantity of lead (often >60% by weight, nearly always >50% by weight) with extremely low optional portions of sodium, potassium and/or boroxide (often >5% by weight). If necessary, they contain small portions of other elements to adjust the refractive index, such as small portions of titanium oxide (refer to SF L 56), for example. These glass types are described in the Schott publication series “Properties of Optical Glass”, for example.

To eliminate the disadvantages of this known glass, the optical glass according to the invention has the following composition (in % by weight, in oxide form):

Variants of this glass having somewhat narrower composition ranges are indicated in subclaims 2 through 4.

Preferably, the total content of alkali oxide of Na₂O and K₂O is between 0.5% and 8% by weight, and the sum of TiO₂, ZrO₂, La₂O₃, ZnO and BaO is between 1% and 7% by weight. In a further preferred embodiment, the lower limit of the sum of TiO₂, ZrO₂, La₂O₃, ZnO and BaO is 2% by weight, and preferably 3% by weight.

The glasses according to the invention have a low stress-optical coefficient of −1.5≦K≦1.5, preferably −1≦K<1 [104 mm²/N] and have good chemical resistance to alkaline substances (alkali resistance, AR) better than or equal to class 3 according to [ISO 10629], and to acids (acid resistance, SR) better or equal to class 53, according to ISO 8424. The Knoop hardness is HK_{0.1;20}≧300. The glasses according to the invention are therefore well suited for all applications that benefit from low stress-optical effects and that require good chemical resistance with a low stress-optical coefficient; this includes the field of application of projection, preferably LCD, particularly rLCD projection, and the fields of imaging in general, and telecommunications.

In addition to the requirement for the desired physical properties, the glasses according to the invention also fulfill the requirement for good melting and workability properties.

For use as optical laser glass or as fiberglass for telecommunications purposes, the glasses according to the invention can be doped with laser-active or optoactive components, such as oxides of the elements Ga, Ge, Y, Nb, Mo, La, Ce, Pr, Nd, Gd, Tb, Dy, Ho, Er, Tn, Yb, Hf, Ta, etc.

The base glass on which the optical glass according to the invention is based comes from the silicate of lead glass system common for heavy flint types having portions of titanium oxides, zirconium oxides, zinc oxides, barium oxides and/or lanthane oxides that are small yet essential to the invention and are therefore mandatory.

The portions of 5-35% by weight of SiO₂ and 55-88% by weight of PbO are the classical heavy flint types of glass-forming substances. They form the basis for the desired optical and physical properties of these glass types, based on which an improvement in the chemical properties was carried out using the titanium oxide, zirconium oxide, zinc oxide, barium oxide and/or lanthane oxide additives that are mandatory in accordance with the invention. In terms of the intended use, a shift in the ratio of glass-forming substances relative to each other results in effects which can be evaluated as negative. It was found, for example, that an increase in the silicon content in favor of the lead portion results in a drastic worsening/increase in the stress-optical coefficients, because these two components are direct antipodes in terms of this optical property. It was also found that a further reduction in the silicon portion in favor of lead, which lowers the K value, brings about a worsening of the chemical resistance and a reduction in the Knoop hardness and, therefore, the determination of the glasses according to the invention. According to the invention, boron trioxide can be added optionally in amounts up to 10% by weight as a third glass-forming substance to provide stabilization against the susceptibility to crystallization. It was also found, according to the invention, that adding more than this has a severe negative influence on the chemical resistance and the K value.

By adding alkali metal oxides, in particular 0-5% by weight Na₂O and/or 0-5% by weight K₂O, it is possible to finely tune the optical position and lower the susceptibility to crystallization, while, in the existing glasses that contain a high content of lead, the properties as flux agent tend to have less significance. Preferably, however, a total content of 8% by weight should not be exceeded, because, in this case, the K value increases greatly, and the glasses can no longer be used as intended.

The lower limit of the total content of alkali metal oxides Na₂O and K₂O is preferably 0.5% by weight.

The addition of TiO₂, ZrO₂, La₂O₃, BaO and/or ZnO (each of them optionally 15% by weight, preferably 10% by weight), which is variable in terms of the combination of its individual components, serves to increase the chemical resistance and Knoop hardness of the glasses according to the invention while maintaining K values that are low and, therefore, that conform with the intended use. The content of these components can also be 0. In a preferred composition, the lower limit is 1% by weight. It was also found that adding more than the total of 15% by weight greatly lowers the crystallization stability, however.

Exemplary embodiments of the optical glass according to the invention are described hereinbelow. Tables 1-4 contain 23 exemplary embodiments in the preferred composition range. These are comparative examples of the improved chemical resistance in relation to the low stress-optical coefficient obtained. To this end, selected examples of the optical glass according to the invention were compared with known types having a corresponding stress-optical coefficient.

The “known types” are the glass types sold by the Schott company, Mainz, under the trade names SF 56, SF 57, SF 58 and SF 59. These glass types are described in the Schott publication series “Properties of Optical Glass”, for example.

The comparison is carried out based on the most comparable basic composition possible and not on an absolute reproduction of the optical position, because, although a strict homogeneity of the refractive values of the individual pieces and a particularly good lot-to-lot reproducibility of an optical position—established one time—are relevant for the intended use, the basic restoration of an optical position known from traditional optical glasses is not.

The glasses according to the invention are preferably free of arsenic. To keep the glass absolutely free of arsenic, arsenic must not be used for refining.

In addition, the glass is preferably free of aluminum and/or aluminium oxide. Basically, fluorides can be used as refining agents that have, as counterion, alkaline-earth and alkaline fluorides or also any other metals contained in the compositions, and antimony oxide and zinc oxide, possibly also chlorides such as sodium chloride.

The present invention also relates to a method for manufacturing the glass according to the invention. In this method, the glass-forming starting components known per se are warmed as salts and/or oxides to form a molten mass that contains 5-35% by weight SiO₂, 55-88% by weight PbO, 0-10% by weight B₂O₃, 0-5% by weight Na₂O and 0-5% by weight K₂O. According to the invention, further components are added, i.e., 0-10% by weight, preferably <5% by weight TiO₂, 0-10% by weight, preferably <5% by weight ZrO₂, 0-10% by weight La₂O₃, 0-10% by weight BaO, and 0-10% by weight ZnO, or they are formed in the molten mass out of suitable starting substances, whereby Σ(Na₂O, K₂O): 0≦x≦8 and Σ(TiO₂, ZrO₂, La₂O₃, ZnO, BaO): ≦15% by weight, preferably 1≦x≦15.

The invention also relates to the use of the glass according to the invention in projectors, in particular rLCD projectors, in microlithography, telecommunications and in optical components, and in such devices that contain glasses of this nature. Preferred projectors are LCD, in particular rLCD projectors. Preferred optical components are optical laser glass and/or fiberglass, in particular for telecommunications.

A manufacturing example for the glasses according to the invention is as follows:

The raw materials for the oxides, preferably carbonates, nitrates and/or fluorides are weighed out, one or more refining agents, such as Sb₂O₃, are added, then the mixture is mixed well. The glass mixture is melted down at approximately 1150° C. in a continual melting unit, then it is refined and homogenized at 1200° C. At a casting temperature of approximately 1000° C., the glass is hot-worked, cooled in a defined manner, then processed further, if necessary, to the desired dimensions.

Melting example for a calculated amount of 100 kg glass:

| Oxide | % by weight | Raw material | Sample wt (kg) |
|---|---|---|---|
| SiO₂ | 24.0 | SiO₂ | 24.11 |
| PbO | 69.5 | Pb₃O₄ | 71.31 |
| Na₂O | 0.4 | Na₂CO₃ | 0.55 |
| | 0.1 | as NaNO₃ | 0.20 |
| K₂O | 0.5 | K₂CO₃ | 0.88 |
| TiO₂ | 5.0 | TiO₂ | 5.03 |
| Sb₂O₃ | 0.5 | Sb₂O₃ | 0.51 |
| Total | 100.0 | | 102.59 |

The properties of the glass obtained in this manner are indicated in Table 2, example 8, hereinbelow.

TABLE 1
Exemplary embodiments based on glass SF 57
(Quantities indicated in % by weight)

| | Base glass | | | | | | | |
|---|---|---|---|---|---|---|---|---|
| Glass | SF 57 | 1 | 2 | 3 | 4 | 5 | 6 | 7 |
| SiO₂ | 24.0 | 24.0 | 24.0 | 24.0 | 24.0 | 23.0 | 22.0 | 19.0 |
| PbO | 74.5 | 73.5 | 73.5 | 72.5 | 69.5 | 71.1 | 74.5 | 74.5 |
| B₂O₃ | | | | | | | | |
| Na₂O | 0.5 | 0.5 | 0.5 | 0.5 | 0.5 | 0.5 | 0.5 | 0.5 |
| K₂O | 0.5 | 0.5 | 0.5 | 0.5 | 0.5 | 0.5 | 0.5 | 0.5 |
| ZnO | | | 1.0 | | | | | |
| TiO₂ | | | | | | | | |
| ZrO₂ | | 1.0 | | 2.0 | 5.0 | 4.8 | 2.0 | 5.0 |
| La₂O₃ | | | | | | | | |
| Sb₂O₃ | 0.5 | 0.5 | 0.5 | 0.5 | 0.5 | 0.5 | 0.5 | 0.5 |
| Total | 100.0 | 100.0 | 100.0 | 100.0 | 100.0 | 100.4 | 100.0 | 100.0 |
| nd | 1.8466 | 1.8523 | 1.8378 | 1.8534 | 1.8597 | 1.8763 | 1.8838 | 1.9374 |
| νd | 23.83 | 23.72 | 23.94 | 23.88 | 24.23 | 23.55 | 22.71 | 21.24 |
| K [10⁻⁶ mm²/N] | 0.02 | 0.22 | 0.22 | 0.16 | 0.43 | 0.43 | −0.29 | −0.74 |
| AR [class] | 2.3 | 2.0 | 2.3 | 1.2 | 1.0 | 2.0 | 1.0 | 1.0 |
| SR [class] | 52.3 | 52.3 | 52.0 | 52.3 | 4.3 | 53.2 | 53.4 | 54.3 |
| Knoop hardness | 350 | 340 | 350 | 350 | 350 | 340 | 340 | 320 |
| Density [g/cm³] | 5.51 | 5.52 | 5.46 | 5.49 | 5.48 | 5.61 | 5.70 | 5.96 |
| α₂₀₋₃₀₀ | 8.3 | 8.8 | 8.4 | 8.5 | 8.2 | 8.4 | 8.9 | 9.3 |
| [10⁻⁶/K] | | | | | | | | |
| Tg [° C.] | 402 | 429 | 423 | 438 | 423 | 431 | 425 | 415 |

TABLE 2
Exemplary embodiments based on glass SF 57
(Quantities indicated in % by weight)

| | Base glass | | | | | | | |
|---|---|---|---|---|---|---|---|---|
| Glass | SF 57 | 8 | 9 | 10 | 11 | 12 | 13 | 14 |
| SiO₂ | 24.0 | 24.0 | 19.0 | 24.0 | 22.0 | 24.0 | 24.0 | 24.0 |
| PbO | 74.5 | 69.5 | 74.5 | 72.5 | 74.5 | 67.6 | 72.5 | 69.5 |
| B₂O₃ | | | | | | | | |
| Na₂O | 0.5 | 0.5 | 0.5 | 0.5 | 0.5 | 0.5 | 0.5 | 0.5 |
| K₂O | 0.5 | 0.5 | 0.5 | 0.5 | 0.5 | 0.5 | 0.5 | 0.5 |
| ZnO | | | | | | | | |
| TiO₂ | | | | | | | | |
| ZrO₂ | | 5.0 | 5.0 | 2.0 | 2.0 | 7.0 | | |
| La₂O₃ | | | | | | | 2.0 | 5.0 |
| As₂O₃, Sb₂O₃ | 0.5 | 0.5 | 0.5 | 0.5 | 0.5 | 0.5 | 0.5 | 0.5 |
| Total | 100.0 | 100.0 | 100.0 | 100.0 | 100.0 | 100.1 | 100.0 | 100.0 |
| nd | 1.8466 | 1.8820 | 1.9624 | 1.861 | 1.900 | 1.8937 | 1.8506 | 1.8497 |
| νd | 23.83 | 22.02 | 19.55 | 22.88 | 21.80 | 21.52 | 23.91 | 24.42 |
| K [10⁻⁶ mm²/N] | 0.02 | 0.41 | −0.73 | 0.15 | −0.34 | 0.56 | −0.07 | −0.06 |
| AR [class] | 2.3 | 1.3 | 1.3 | 2.3 | 2.0 | 1.3 | 1.0 | 1.0 |
| SR [class] | 52.3 | 2.2 | 4.0 | 51.3 | 52.3 | 1.0 | 51.3 | 52.2 |
| Knoop hardness | 350 | 390 | 340 | 350 | 340 | 400 | 340 | 350 |
| Density [g/cm³] | 5.51 | 5.33 | 5.85 | 5.45 | 5.65 | 5.25 | 5.52 | 5.50 |
| α₂₀₋₃₀₀ | 8.3 | 8.4 | 9.5 | 8.9 | 9.3 | 8.2 | 9.1 | 8.8 |
| [10⁻⁶/K] | | | | | | | | |
| Tg [° C.] | 402 | 457 | 436 | 433 | 420 | 477 | 423 | 445 |

TABLE 3
Exemplary embodiments based on glasses SF 58 and SF 59
(Quantities indicated in % by weight)

| | Base | | | | Base | | | |
|---|---|---|---|---|---|---|---|---|
| | glass | | | | glass | | | |
| Glass | SF 57 | 15 | 16 | 17 | SF 59 | 18 | 19 | 20 |
| SiO₂ | 18.8 | 18.8 | 18.8 | 18.8 | 15.0 | 15.0 | 13.0 | 15.0 |
| PbO | 78.5 | 76.5 | 71.5 | 73.5 | 80.9 | 75.9 | 80.9 | 78.9 |
| B₂O₃ | 1.5 | 1.5 | 1.5 | 1.5 | 3.0 | 3.0 | 3.0 | 3.0 |
| Na₂O | | | | | | | | |
| K₂O | 0.7 | 0.7 | 0.7 | 0.7 | 0.5 | 0.5 | 0.5 | 0.5 |
| ZnO | | | 7.0 | | | 5.0 | | |
| TiO₂ | | | | | | | | |
| ZrO₂ | | 2.0 | | | | | 2.0 | |
| La₂O₃ | | | | 5.0 | | | | 2.0 |
| Sb₂O₃ | 0.5 | 0.5 | 0.5 | 0.5 | 0.6 | 0.6 | 0.6 | 0.6 |
| Total | 100.0 | 100.0 | 100.0 | 100.0 | 100.0 | 100.0 | 100.0 | 100.0 |
| nd | 1.9176 | 1.9234 | 1.9576 | 1.9202 | 1.9525 | 1.9808 | 1.9823 | 1.9557 |
| νd | 21.51 | 21.55 | 19.55 | 22.01 | 20.36 | 18.91 | 19.46 | 20.42 |
| K [10⁻⁶ mm²/N] | −0.93 | −0.81 | −0.47 | −1.00 | −1.36 | −1.05 | −1.61 | −1.43 |
| AR [class] | 3.3 | 2.3 | 3.0 | 2.0 | 3.3 | 3.0 | 2.3 | 2.3 |
| SR [class] | 53.3 | 54.0 | 2.1 | 53.2 | 53.3 | 3.3 | 54.3 | 53.3 |
| Knoop | 320 | 320 | 360 | 320 | 300 | 330 | 290 | 290 |
| hardness | | | | | | | | |
| Density [g/cm³] | 5.95 | 5.93 | 5.73 | 5.94 | 6.26 | 6.12 | 6.41 | 6.27 |
| α₂₀₋₃₀₀ | 10.1 | 10.3 | 10.0 | 10.5 | 10.9 | 11.0 | 11.4 | 11.5 |
| [10⁻⁶/K] | | | | | | | | |
| Tg [° C.] | 377 | 408 | 441 | 414 | 356 | 400 | 374 | 373 |

TABLE 4
Exemplary embodiments based on glasses SF 56
(Quantities indicated in % by weight)

| | Base glass | | | |
|---|---|---|---|---|
| Glass | SF 56A | 21 | 22 | 23 |
| SiO₂ | 29.2 | 29.2 | 27.2 | 29.2 |
| PbO | 67.1 | 65.1 | 67.1 | 66.1 |
| Na₂O | 0.8 | 0.8 | 0.8 | 0.8 |
| K₂O | 1.5 | 1.5 | 1.5 | 1.5 |
| TiO₂ | 1.2 | 1.2 | 3.2 | 1.2 |
| ZrO₂ | | | | 1.0 |
| La₂O₃ | | 2.0 | | |
| Sb₂O₃ | 0.2 | 0.2 | 0.2 | 0.2 |
| Total | 100.0 | 100.0 | 100.0 | 100.0 |
| nd | 1.7847 | 1.7891 | 1.8434 | 1.7910 |
| νd | 26.08 | 26.17 | 23.85 | 25.97 |
| K [10⁻⁶ mm²/N] | 1.10 | 1.00 | 0.70 | 1.10 |
| AR [class] | 2.2 | 1.0 | 1.3 | 1.3 |
| SR [class] | 3.2 | 2.3 | 3.2 | 3.2 |
| Knoop hardness | 380 | 370 | 370 | 370 |
| Density [g/cm³] | 4.92 | 4.93 | 5.07 | 4.93 |
| α₂₀₋₃₀₀ | 8.8 | 9.7 | 9.9 | 9.4 |
| [10⁻⁶/K] | | | | |
| Tg [° C.] | 433 | 456 | 453 | 463 |

The present invention relates to optical glasses from the heavy flint glass and lanthane heavy flint glass type that have special optical, chemical and physical properties that qualify them for use in fields of application that benefit from low stress-optical effects in their glass components (e.g., by utilizing polarization effects, as in projection, refraction index homogeneities as in microlithography or telecommunications) or due to a coating compatibility in the optical sense (e.g., with special optical components).

The excellent properties include, among others, the stress-optical coefficient that approaches zero combined with good chemical resistance and sufficient Knoop hardness, and good melting and workability properties.

The glasses according to the invention can be doped for the likewise feasible use as optical laser glass or as fiberglass for telecommunications purposes with laser-active or optoactive components (for example: oxides of the elements Ga, Ge, Y, Nb, Mo, La, Ce, Pr, Nd, Gd, Tb, Dy, Ho, Er, Tn, Yb, Hf, Ta).

1. Optical glass from the heavy flint glass and lanthane heavy flint glass type, characterized by the composition (in % by weight)

| | |
|---|---|
| SiO₂ | 5-35 |
| PbO | 55-88 |
| B₂O₃ | 0-10 |
| Na₂O | 0-5 |
| K₂O | 0-5 |

6 (Na₂O; K₂O): 0 ≦ x ≦ 8

| | |
|---|---|
| TiO₂ | 0-10 |
| ZrO₂ | 0-10 |
| La₂O₃ | 0-10 |
| BaO | 0-10 |
| ZnO | 0-10 |

6 (TiO₂; ZrO₂; La₂O₃; ZnO; BaO): x ≦ 15.

2. Optical class as recited in claim 1, characterized by the composition (in % by weight)

| SiO₂ | 8-32 |
|---|---|
| PbO | 58-85 |
| B₂O₃ | 0-5 |
| Na₂O | 0-3 |
| K₂O | 0-5 |
| 6 (Na₂O; K₂O): 0 ≦ x ≦ 7 | |
| TiO₂ | 0-7 |
| ZrO₂ | 0-7 |
| La₂O₃ | 0-7 |
| BaO | 0-7 |
| ZnO | 0-7. |

3. Optical class as recited in claim 1, characterized by the composition (in % by weight)

| | |
|---|---|
| SiO₂ | 10-30 |
| PbO | 60-81 |
| B₂O₃ | 0-3 |
| Na₂O | 0-2 |
| K₂O | 0-3 |

6 (Na₂O; K₂O): 0 ≦ x ≦ 5

| | |
|---|---|
| TiO₂ | 0-7 |
| ZrO₂ | 0-5 |
| La₂O₃ | 0-5 |
| BaO | 0-5 |
| ZnO | 0-5 |

6 (TiO₂; ZrO₂; La₂O₃; ZnO; BaO): x ≦ 10.

4. Optical class as recited in claim 1, characterized by the composition (in % by weight)

| SiO₂ | 10-26 |
|---|---|
| PbO | 66-81 |
| B₂O₃ | 0-3 |
| Na₂O | 0-1 |
| K₂O | 0-2 |
| 6 (Na₂O; K₂O): 0 ≦ x ≦ 5 | |
| TiO₂ | 0-5 |
| ZrO₂ | 0-5 |
| La₂O₃ | 0-5 |
| BaO | 0-5 |
| ZnO | 0-5 |

5. Optical glass as recited in claim 1,
wherein the lower limit of the sum of (Na₂O; K₂O) is 0.5% by weight.

6. Optical glass as recited in claim 1,
wherein the upper limit of the sum of (TiO₂; ZrO₂; La₂O₃; ZnO; BaO) is 7% by weight.

7. Optical glass as recited in claim 1,
wherein the lower limit of the sum of (TiO₂; ZrO₂; La₂O₃; ZnO; BaO) is 3% by weight.

8. Optical glass as recited in claim 1,
wherein the lower limit of the sum of (TiO₂; ZrO₂; La₂O₃; ZnO; BaO) is 2% by weight.

9. Optical glass as recited in claim 1,
wherein the glass is doped with laser-active or optoactive components.

10. Optical glass as recited in claim 9,
wherein the glass is doped with one or more oxides of the elements Ga, Ge, Y, Nb, Mo, La, Ce, Pr, Nd, Gd, Tb, Dy, Ho, Er, Tn, Yb, Hf, Ta.

11. A method for manufacturing optical glasses from the heavy flint glass type by producing a molten mass of
5-35% by weight of SiO₂
55-88% by weight of PbO
0-10% by weight of B₂O₃
0-5% by weight of Na₂O
0-5% by weight of K₂O
then quenching the molten mass by solidification.

12. The use of the optical glass as recited in claim 1 in projectors, in particular rLCD projectors, in microlithography, telecommunications and in optical components.
